(19) United States
(12) Patent Application Publication
(10) Pub. No.: US 2015/0310427 A1
(43) Pub. Date: Oct. 29, 2015

(54) METHOD, APPARATUS, AND SYSTEM FOR GENERATING TRANSACTION-SIGNING ONE-TIME PASSWORD

(71) Applicant: Xilix LLC, Seoul (KR)

(72) Inventors: Dong Keun YI, Seongnam-si (KR); Geun Mook KIM, Seongnam-si (KR); Byung Young LEE, Anyang-si (KR)

(21) Appl. No.: 14/689,014

(22) Filed: Apr. 16, 2015

(30) Foreign Application Priority Data
Apr. 24, 2014 (KR) 10-2014-0049479
Mar. 25, 2015 (KR) 10-2015-0041699

(51) Int. Cl. G06Q 20/38

(52) U.S. Cl. CPC G06Q 20/385; G06Q 20/382; G06Q 2220/00

(57) ABSTRACT

Disclosed herein are a method, apparatus and system for generating a transaction-signing One-time password. The method includes transmitting a payment request to a payment server using a trusted application running on a client terminal, receiving transaction information in response to the transaction request, and generating a transaction-signing OTP including the transaction information as an input value by using the trusted application.

### CROSS-REFERENCE TO RELATED APPLICATION

This application claims the benefit of Korean Patent Application Nos. 10-2014-0049479 filed on Apr. 24, 2014 and 10-2015-0041699 filed on Mar. 25, 2015 which are hereby incorporated by reference in its entirety into this application.

### BACKGROUND OF THE INVENTION

1. Field of the Invention

The present invention relates generally to a method, apparatus, and system for generating a transaction-signing One-time password (OTP) and, more particularly, to a method and system that generate an OTP including transaction information by using a security Operating System (OS) independently running on a client terminal.

2. Description of the Related Art

With an increase in the utilization of digital devices such as computers or smart phones, electronic commerce (e-commerce) and mobile commerce (m-commerce) using such a digital device have become widely used in various fields. In particular, since a mobile terminal such as a smart phone has the advantage of being always carried by a user, various financial applications for mobile phones have been released to improve the convenience of users.

In financial transactions using smart phones, an OTP input scheme, instead of various methods such as an existing security card, a Universal Serial Bus (USB) security key, a Short Message Service (SMS) OTP, Completely Automated Public Turing test to tell Computers and Humans Apart (CAPTCHA) (virtual keyboard), and SMS, has been commercialized as a security and authentication function. However, a conventional OTP scheme is inconvenient in that it requires a user to hold a separate OTP generation terminal, and there is concern about the loss of the terminal. Recently, the risk of hacking has even appeared.

In order to solve the inconvenience of requiring a user to hold an OTP generation terminal, among such problems, an OTP generation/authentication system using a mobile phone equipped with an OTP generation program is disclosed in Korean Patent No. 10-0883154. The above patent merely installs and runs a simple OTP generation program in a Universal Subscriber Identity Module (USIM) chip and has the disadvantage of being easily hacked and being vulnerable to security attacks.

In addition, there may occur cases where an OTP number is leaked or hacked in the stage of inputting/outputting the OTP number, thus successively resulting in financial damages. For example, when money is transferred, even if a correct account number and a correct transfer amount are displayed to a user, data may be forged at a backend stage, and thus an incorrect transfer amount may be transferred to an incorrect transfer account. Therefore, in an existing OTP generation method that simply uses random numbers, the introduction of a new scheme capable of preventing the risk of hacking is required.

### SUMMARY OF THE INVENTION

An object of the present invention is to provide a method, apparatus, and system for generating a transaction-signing OTP to solve the above problems.

In accordance with a first aspect of the present invention, there is proposed a method for generating a transaction-signing One-Time Password (OTP), including transmitting a payment request to a payment server using a trusted application running on a client terminal, receiving transaction information in response to the transaction request, and generating a transaction-signing OTP including the transaction information as an input value by using the trusted application.

In accordance with a second aspect of the present invention, there is proposed an apparatus for generating a transaction-signing OTP using a trusted application, including an interface for transmitting a transaction request to a payment server through the trusted application and receiving transaction information in response to the transaction request, an OTP generation processor for generating a transaction-signing OTP using the received transaction information as an input value, and a display unit for displaying processing status of a transaction depending on a user's input using the interface, and displaying the received transaction information, wherein the interface transmits the transaction-signing OTP generated by the OTP generation processor to the payment server, receives results of verification, and displays the results of verification on the display unit.

In accordance with a third aspect of the present invention, there is proposed a system using a transaction-signing OTP, including a client terminal for transmitting a transaction request using a trusted application, receiving transaction information in response to the transaction request, and generating a transaction-signing OTP including the transaction information as an input value, a payment server for receiving the transaction request and transmitting a transaction-signing request, a verification server for receiving the transaction-signing request and transferring the transaction-signing request to a push server, and the push server for receiving the transaction-signing request from the verification server, and transmitting the transaction information corresponding to the transaction-signing request to the client terminal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a system using a transaction-signing OTP according to an embodiment of the present invention;

FIG. 2 illustrates the operating system of a client terminal used for the generation of a transaction-signing OTP according to an embodiment of the present invention;

FIG. 3A illustrates the normal operation of a client terminal according to an embodiment of the present invention, FIG. 3B comparatively illustrates an operation upon using a transaction-signing OTP according to another embodiment of the present invention, and FIG. 3C illustrates an example of a trusted UI according to an embodiment of the present invention;

FIG. 4 is a flowchart showing a method for generating a transaction-signing OTP according to an embodiment of the present invention;

FIG. 5 is a swimlane diagram showing a transaction method using a transaction-signing OTP according to an embodiment of the present invention;

FIG. 6 illustrates a key update protocol for a transaction-signing OTP according to an embodiment of the present invention;

FIG. 7 illustrates a reissuance protocol for a transaction-signing OTP according to an embodiment of the present invention;

FIGS. 8A and 8B illustrate a unlock protocol for a transaction-signing OTP on a client terminal or a payment server according to an embodiment of the present invention;

FIGS. 9A and 9B illustrate a screen shot showing an execution screen of a trusted UI according to an embodiment of the present invention; and

FIG. 10 is a diagram showing an end-to-end (E2E) protocol according to an embodiment of the present invention.

The same reference numerals and symbols are used to designate the same components through different drawings.

### DESCRIPTION OF THE PREFERRED EMBODIMENTS

Embodiments of the present invention are described with reference to the accompanying drawings. It should be noted that the same reference numerals are used to designate the same or similar elements throughout the drawings. In the following description of the present invention, detailed descriptions of related known configurations or functions which are deemed to make the gist of the understanding of the present invention obscure will be omitted. In the present specification, an expression that a first component includes a second component means that additional components may be further included in addition to the second component.

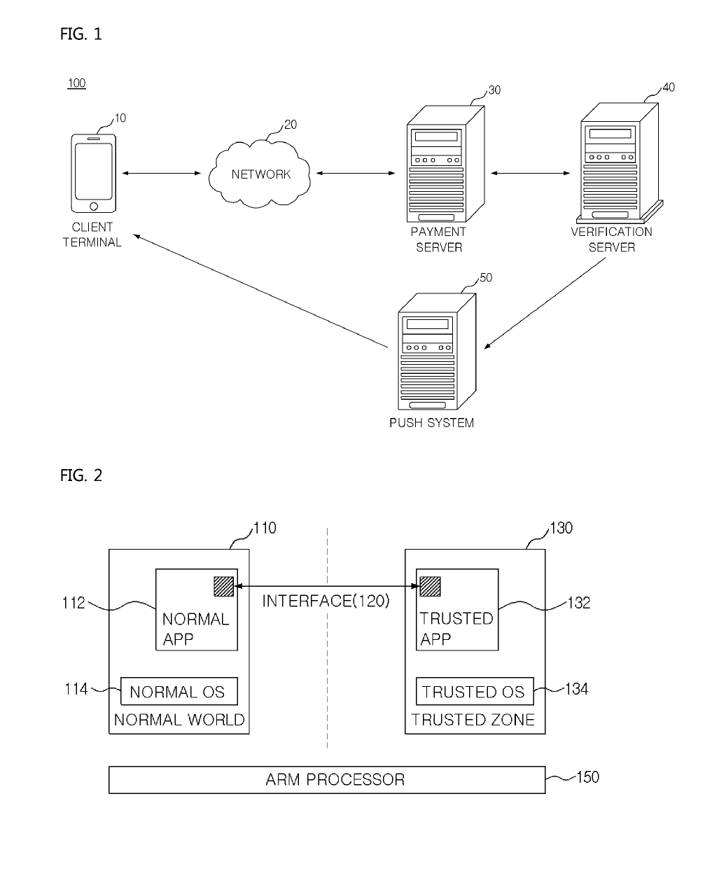

FIG. 1 is a diagram showing a system 100 using a transaction-signing OTP according to an embodiment of the present invention. The system 100 includes a client terminal 10, a payment server 30, a verification server 40, and a push system 50. The components 10, 30, 40, and 50 are capable of mutually communicating with each other over a wired/wireless network 20. In the present drawing, although the payment server 30, the verification server 40, and the push system 50 are shown as being separate components, some or all of the components 30, 40, and 50 may be implemented to be combined with each other.

The client terminal 10, which is device capable of accessing the payment server 30 to perform online financial transactions, denotes any computing device installed with hardware and software enabling financial transactions, e-commerce, and m-commerce. The client terminal 10 may be, not only any of various digital computers such as a laptop, desktop, workstation or other suitable computers, but also any of mobile devices such as computing devices, for example, a Personal Digital Assistant (PDA), a cellular phone, and a smart phone. The client terminal 10 may also include any communicable digital device such as an Internet Protocol TV (IPTV) using Internet protocols. Although the description of the present invention will be made based on a smart phone having performance and mobility rivaling the computers, the present invention is not limited thereto.

The outstanding characteristics of a smart phone are that, unlike existing mobile phones that are released as complete products and enable only given functions thereof to be used, several hundred types of applications (application programs) may be freely installed, added or deleted according to a user's intention. In addition, a smart phone user may not only directly access the Internet wirelessly, but also access Internet content using various methods based on various browsing programs. Furthermore, a smart phone may be conveniently used in real life regardless of the fields of utilization, such as mobile Internet banking, mobile credit card payments, mobile social networking, and mobile shopping. For this, banks, securities companies, credit card companies, social commerce companies, and Internet shopping mall companies develop their own unique smart phone applications in conformity with the operating systems of the corresponding smart phones, and distribute the applications to users for free or at a cost. In this way, with the advent of mobile communication terminals having powerful performance rivaling a computer and mobility based on a network function, the present invention will be described based on a case where a user mobile terminal 200 is a smart phone.

For reference, an application, which is a kind of software running on an Operating System (OS), denotes a program designed to directly perform a specific function for a user or for other application programs. A security application used in the client terminal such as the smart phone according to the embodiment of the present invention may be a mobile application produced to be applied to mobile devices. A mobile application may be implemented in the form of a browser-based application accessing the web, a native application produced according to the terminal depending on the OS of the terminal, or a hybrid application in which those applications are combined with each other. In a computer-readable storage medium, application data, system data, etc. are recorded and stored in a predetermined programming language (e.g., C language or Java). The application data denotes data having various types of program functions implemented to interact with the user (e.g., a function of switching a screen by recognizing the user's touch on a display screen), and is also referred to as ‘full mode’ data. The system data denotes data including application management information, startup information, etc., and refers to attribute and operation information required to reproduce the application data. Information required to implement other, additional functions may be stored in the storage medium.

The client terminal 10 according to the present invention has hardware and software capable of executing various applications on the terminal. In particular, in the present invention, the client terminal 10 includes a processor for running a security OS (trusted OS) on which applications enabling authentication, financial transactions, and payment processing that use a trusted application are executed.

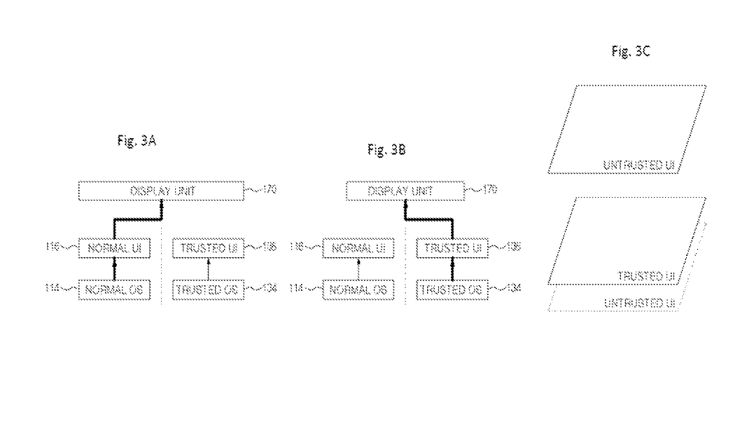

The client terminal 10 of the present invention is characterized in that, upon performing financial transactions, financial transactions are performed using a trusted OS running independent of a normal OS used for the execution of normal applications of the client terminal 10. In this way, an environment in which a trusted OS and a trusted application are running in the client terminal 10 is called a Trusted Execution Environment (TEE) (e.g., trust zone). The present invention relates to a TEE-based financial transaction. A TEE-based operation will be described in greater detail later with reference to FIGS. 2 and 3.

The client terminal 10 may also be used in, for example, normal financial transactions such as a banking service, and e-commerce and m-commerce using the websites of affiliated stores or online shopping malls. The client terminal 10 accesses the payment server 30 over the network 20 and performs a transaction process conforming to the guidance of service. In this case, the network 20 may be implemented using digital data communication (e.g., communication network) for any form or medium. Examples of the communication network include a Local Area Network (LAN), a Wide Area Network (WAN), and the Internet, and include various types of wireless communication such as third generation (3G), Wireless Fidelity (WiFi), and Long-Term Evolution (LTE) to be implemented using various mobile networks.

The payment server 30 may be a server operated by banks or financial institutions for financial transactions, or an online payment server for e-commerce and m-commerce. The payment server 30 receives a transaction or payment request from the client terminal 10, performs procedures such as authentication and verification, and transmits the results of transactions to the client terminal to notify the client terminal whether the transactions have been terminated. In this case, upon performing authentication or verification, verification may be performed in conjunction with the verification server 40. The verification server may be operated by the same agent as an agent operating the payment server 30, or by a separate verification institution.

The push system 50 functions to send a push message to the client terminal 10 in response to a push request received from the payment server or the verification server. In an embodiment of the present invention, the push system 50 may transmit transaction information for the generation of a transaction-signing OTP on the client terminal 10 in the form of a push message.

By using the components 10, 20, 30, 40, and 50, the present invention is characterized in that, upon performing financial transactions, e-commerce, and m-commerce using a smart phone, transaction information including a transfer amount and an account number is transmitted to the client terminal 10 through the payment server, the verification server, and the push system, and in that the client terminal 10 generates an OTP using the received transaction information. Hereinafter, an OTP generated using transaction information is referred to as a “transaction-signing OTP.” Even if an OTP number is leaked in the stage of inputting/outputting the OTP number, the transaction-signing OTP may be verified using transaction information in a verification stage, thus realizing the advantage of preventing the OTP from being used for other transactions and of improving security. The transaction-signing OTP proposed in the present invention includes transaction information such as a bank ID code, an account number, and a transfer amount upon performing a financial transaction, and includes transaction information such as the name of a purchased product, a purchase amount, and a purchasing place upon performing e-commerce and m-commerce. Input values (transaction information) for the generation of such a transaction-signing OTP may be input as numeric or character data. In the present embodiment, pieces of transaction information to be designated not to be changed in transactions have been selectively set to input values, but the present invention is not limited to such an embodiment and may be implemented such that other transaction information is additionally input to generate a transaction-signing OTP.

Further, since a transaction-signing OTP is generated on a trusted application using a trusted OS independently running on the client terminal, safety and security may be ensured and, in addition, the OTP is capable of replacing various types of security means such as a security card, a hardware OTP token device, a USB security key, a SMS OTP, CAPTCHA (virtual keyboard), SMS, and a certificate, and does not need additional authentication, thus improving the user's convenience. Moreover, a conventional scheme enables a user to check transfer details or purchase/payment details upon performing a financial transaction or e-commerce and m-commerce, but is problematic in that in actual transactions, an account number or the like is changed due to hacking. In contrast, in the case of a transaction-signing OTP proposed in the present invention, a transaction-signing OTP is generated from the transaction information itself checked on the smart phone without change, thus preventing damage caused by a change in data values during transactions.

In particular, a transaction-signing OTP has, as essential features, technology for allowing a customer to personally check his or her transaction details and input corresponding contents. In spite of an advantage in which a transaction-signing OTP is more secure than a current scheme, the transaction-signing OTP has not yet been commercialized to date due to an inconvenience causing a customer to re-input the same transaction details. However, when an OTP is implemented according to the Trust Zone (TZ) OTP scheme proposed in the present invention, a customer may check his or her transaction details, and the transaction details may be automatically input in a secure manner even if the customer does not re-input the transaction details, thus improving convenience and enabling a transaction-signing OTP to be commercialized. Further, memory hacking or the like may be prevented using a scheme similar to that of a current scheme, thus satisfying security and practicability.

The present invention is advantageous in that it may provide a hardware-based separated TEE, and, in particular, completely prevent the forgery/falsification of data at an input/output stage via the implementation of trusted UI technology, and also prevent data transmission and a screen capture, thus compensating for vulnerabilities in software-based security technology, and guaranteeing integrity at the input/output stage.

A transaction-signing OTP scheme according to the present invention may be individually applied to a time synchronization scheme corresponding to a conventional OTP generation scheme, a time synchronization-event combination scheme, and a challenge-response scheme.

A detailed transaction-signing OTP generation method will be described in detail below with reference to FIGS. 2 to 5.

FIG. 2 illustrates the OS of a client terminal 10 used to generate a transaction-signing OTP according to an embodiment of the present invention. The client terminal 10 according to the present invention has a normal world 110 in which a normal OS 114 and a normal application 112 run, and also has a security world (Trusted Execution Environment: TEE) 130 operating independent of the normal world. Within the TEE 130 that is the security environment, a security OS (trusted OS) 134 and a security application (trusted App) 132 run independent of the normal OS 114 and the normal application 112, but may share part or all of a user interface 120, as shown in FIG. 2. Further, the client terminal 10 includes a TEE technology-based Advanced RISC Machines (ARM) processor 150 capable of selectively operating the TEE 130 and the normal world 110.

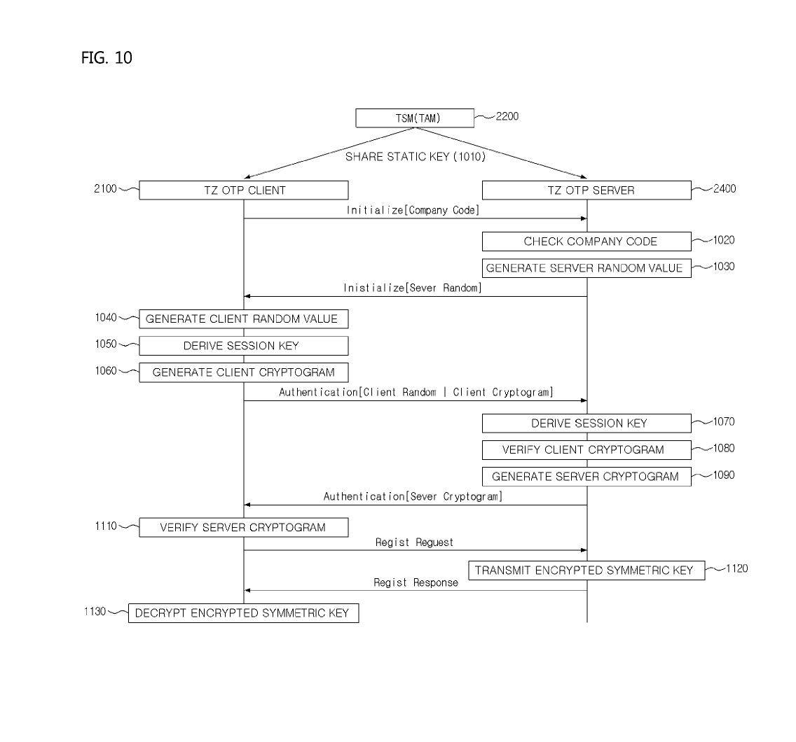

The TEE 130 includes the trusted OS 134 supporting the TEE and the trusted App 132 executed by the trusted OS. The TEE 130 denotes hardware-based Trusted Execution Environment (TEE) technology for logically separating a mobile CPU (AP) of a client terminal such as a smart device into a normal zone (normal world) and a TEE, and for restricting access to the TEE. The TEE and the normal world 110 are logically separated and are implemented to be inaccessible to each other except for the predefined interface 120 and a shared memory, thus enabling communication only via the predefined interface and prohibiting other access. Further, the TEE 130 is limited so that only a service provider authorized by a Trusted Service Manager (TSM) may install and use an application, and is characterized by being completely and separately operated in a separate zone and having higher priority than normal OSs upon booting. In this way, by implementing a completely separate TEE, an E2E key, a private key, etc. may be securely stored. An E2E encryption scheme will be described in detail later with reference to FIG. 10.

As an embodiment, data stored using the trusted App 132 in the TEE 130 may be stored in an encrypted form in the normal world 110, but it cannot be decrypted in the normal world and on other trusted Apps in the same terminal. As another embodiment, even the same type of App as the trusted App 132 cannot be decrypted in other devices.

Since the TEE 130 is logically, completely separated and independently runs in this way, financial information may be securely stored and processed upon performing financial transactions or e-commerce and m-commerce using the client terminal 10. The TEE-based trusted App 132 may implement security authentication and security log-in, generate a transaction-signing OTP proposed in the present invention, and encrypt and store information requiring security, such as certificates.

In particular, the TEE-based trusted App 132 implements a trusted User Interface (Trusted UI) to realize security authentication or security log-in, thus enabling a secure transaction-signing OTP to be generated in the TEE, and securely processing information requiring security, such as a certificate. Further, new technology for combining the trusted UI with an E2E encryption scheme, which will be described later, is implemented in the TEE, thereby enabling an unhackable transaction-signing OTP to be implemented. The trusted UI will be described in detail later with reference to FIG. 3.

As an embodiment, the trusted App 132 of the present invention may perform a log-in or authentication process requiring security, upon performing normal e-commerce and m-commerce, as well as financial transactions. Furthermore, the trusted App 132 of the present invention may generate a transaction-signing OTP using transaction information, and the transaction-signing OTP may replace various types of security means such as a security card, a hardware OTP token device, a USB security key, a SMS OTP, CAPTCHA (virtual keyboard), SMS, and a certificate, thus enabling convenient and secure transactions. Further, such a transaction-signing OTP may be utilized as an authentication means even in the Internet of Things (IoT) or the like. Since the transaction-signing OTP proposed in the present invention is substantially generated without requiring a physical medium, there is an advantage in that the user may be easily issued an OTP online without personally visiting a financial institution such as a bank (e.g., a transaction-signing OTP may be implemented to be issued using an online institution such as a bank exclusive to the Internet).

FIG. 3A illustrates the normal operation of the client terminal 10 according to an embodiment of the present invention, FIG. 3B comparatively illustrates an operation performed in the TEE 130 according to another embodiment of the present invention, and FIG. 3C illustrates an example of a trusted UI.

As described above with reference to FIG. 2, the normal world 110 and the TEE 130 are logically separated from each other. Upon executing the normal App 112, the normal OS 114 supports an operation and a normal User Interface (UI) 116 is displayed on the display unit 170 (FIG. 3A).

In contrast, upon executing the trusted App 132, the trusted OS 134 supports an operation, and a security UI (trusted UI) 136 is displayed on the display unit 170 (FIG. 3B). Since the Trusted User Interface (hereinafter also referred to as “TUI”) 136 is displayed with the highest priority at a level higher than that of the normal UI, as shown in FIG. 3C, it is inaccessible in the normal world 110. Further, since the trusted UI 136 is implemented so that screen touch coordinates or the like cannot be recognized in the normal world 110, the security of financial transactions or e-commerce and m-commerce performed via the TEE 130 may be pursued.

In particular, when the TUI 136 is executed, it is impossible to externally extort any information that is input or output. When a security screen is executed, the TEE exclusively uses a CPU, so that all operations and actions performed in the normal world are temporarily stopped, and an application (App) in the TEE based on a separate OS (that is, the trusted OS) runs, and thus an attacker's access itself is blocked. In this case, the present invention is configured such that even hardware control keys such as a home button and a back button are not executed with the exception of a keypad for input, thus blocking hardware-based data transmission, such as a capture or a recording, and such that, in order to return to the normal world, such a return operation is possible only through a SW back button provided by the TUI. For example, when a smart phone in which the TEE is installed is connected to a PC, and a PC screen is displayed via a projector, if a TZ OTP is executed on the smart phone, the screen of the smart phone is changed from a moment at which the trusted UI screen is executed, but an output port is interrupted and then nothing is displayed on the screens of the PC and the projector.

When a trusted UI is executed, a TEE may acquire all authority to input/output the screen and block the input/output of data, and may prohibit the capture or recording of the output screen. For example, even if a trusted screen is implemented via an existing software security scheme, there is no method capable of blocking a screen capture based on a hardware capture scheme of a client device (e.g., a scheme for capturing the screen when a home key and a power key are simultaneously pressed). However, when the trusted UI 136 implemented in the present invention is executed, a screen capture or recording is prevented from being performed even by a screen capture operation, thus compensating for vulnerability in existing security methods. Further, all coordinate values input to the screen are prevented from being externally extorted, thus blocking the forgery/falsification of data. When such a trusted UI is executed, an additional security device such as an existing virtual keyboard is not required, so that the forgery/falsification of data is prevented without requiring a separate security solution, and the security of a keyboard and coordinate values becomes possible, resulting in an advantage of economical efficiency.

The trusted UI 136 is used for an OTP PIN number entry screen and an OTP generation result screen, so that even OTP generation values may be securely protected from a risk of hacking via a trusted UI screen after the PIN number has been authenticated.

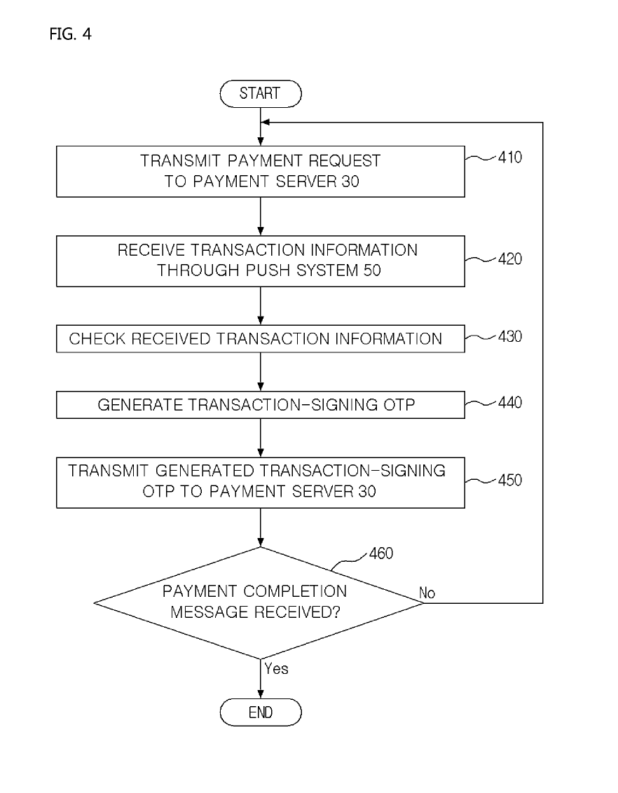

FIG. 4 is a flowchart showing a method for generating a transaction-signing OTP according to an embodiment of the present invention. The client terminal 10 of the present invention enables financial transactions, e-commerce, and m-commerce using a transaction-signing OTP while operating in conjunction with the payment server 30, the verification server 40, and the push system 50.

The client terminal 10 according to the present invention performs transactions using a transaction-signing OTP, based on the trusted App 132. Here, when the user selects a menu requiring security, such as OTP registration and checking, via a normal UI screen executed in the normal world by executing a normal application, the normal application calls (or links to) a trusted application to run the trusted application. The trusted application runs together with the implementation of the trusted UI upon executing the menu requiring security, and may be switched back to a normal application mode via a predefined key.

As an embodiment, the client terminal 10 receives input information required for transactions, such as a payment amount (or a transfer amount) and a transfer account, depending on the user's input upon performing financial transactions or e-commerce and m-commerce, and transmits a payment request for transaction processing to the payment server 30 (step 410). For example, when an account transfer is executed by running a bank App on the smart phone, if the user runs the bank App, the bank App may be executed in the TEE 130 to receive information from the user through the trusted UI 136, and transmit the received information to the payment server 30.

In this case, an authentication procedure for initialization between the client terminal 10 and the payment server 30 is performed. The authentication procedure is performed in such a way that the client terminal generates a signature value using a client public key and transmits the signature value to the payment server 30, and that the payment server 30 having received the signature value generates a signature value using a server public key and transmits the signature value to the client terminal 10. When the client terminal 10 and the payment server 30 transmit and receive data for authentication, the data may include user-random or server-random values. The reason for this is to prevent the reuse of the OTP. Next, the client terminal 10 may generate a session key, encrypt the session key using a server public key, and transmit the encrypted session key to the payment server 30. The payment server 30 generates a serial value and a seed value, encrypts the serial value and the seed value using a session key, and transmits the encrypted values to the client terminal 10, thus sharing the serial value and the seed value, and completing an initialization process.

After connection for a transaction between the client terminal 10 and the payment server 30 has been made, a financial transaction or e-commerce and m-commerce process is performed via the trusted App 132 on the client terminal 10, and an authentication or transaction (payment) request may be transmitted to the payment server 30 if necessary, at step 410. After receiving the payment request for a transaction from the client terminal, the payment server 30 transfers a transaction-signing request to the verification server 40, and the verification server 40 transfers transaction information to the client terminal 10 through the push system 50 at step 420. The client terminal 10 may receive transaction information including a transfer amount, an account number, a transfer bank (bank ID code), etc. from the push system 50, and may check the received transaction information on the client terminal 10 at step 430. In the detailed description of the present invention, although a description has been made based on a configuration in which transaction information is transferred through the push system 50, other embodiments may be implemented such that transaction information is transferred from the payment server 30 or the verification server 40 to the client terminal 10 without passing through the push system 50.

When the transaction information is received, the client terminal 10 generates a transaction-signing OTP by using the received transaction information as input values at step 440. The present invention is characterized in that, unlike a hardware OTP token device, a ‘transaction-signing OTP’ is generated using the transaction information. The transaction-signing OTP is a not a simple random number that is randomly generated, but is an OTP including the transaction information as input values. That is, the OTP denotes a one-time password that cannot be estimated using a generated OTP number, but enables transaction information to be checked at the time of verification. For example, the OTP number of a hardware OTP token device is implemented as a 6-digit number, but a transaction-signing OTP may be implemented as an 8-digit number.

As an embodiment, the transaction information may include a bank ID code, an account number, and a transfer amount, and the trusted App 132 of the client terminal 10 may generate an OTP by utilizing an OTP generation algorithm in which transaction information is used as input values. As described above, the transaction-signing OTP proposed in the present invention includes transaction information such as a bank ID code, an account number, and a transfer amount upon performing financial transactions, and includes transaction information such as the name of a purchased product, a purchase amount, and a purchasing place upon performing e-commerce and m-commerce. Input values (transaction information) for the generation of such a transaction-signing OTP may be input as numeric or character data. In the present embodiment, pieces of transaction information to be designated not to be changed in transactions have been selectively set to input values, but the present invention is not limited to such an embodiment and may be implemented such that other transaction information is additionally input to generate a transaction-signing OTP.

After being received through the push system 50, the transaction information is automatically used as input values to generate an OTP, and thus there is an advantage in that inconvenience of requiring the user to separately input transaction information may be reduced, and an OTP may be generated using an existing terminal held by the user without requiring a separate OTP device.

Since the transaction-signing OTP uses trusted UI technology, extortion of the OTP to the outside and forgery of the OTP at an OTP input/output stage are actually impossible. Even if the OTP is hacked or leaked at the OTP input/output stage and is used by a third party, the OTP includes transaction information, so that a transaction is impossible if the transaction information included in the OTP is different from the transaction information transmitted through the push system 50 in a verification procedure. Therefore, when the trusted UI technology of the present invention is used, external access to data and data extortion to the outside are impossible owing to hardware-based security. Even if an OTP is leaked to a third party using a physical method, it cannot be used for any financial transaction or e-commerce and m-commerce, thus preventing the occurrence of various financial accidents. In this way, a transaction-signing OTP improves security and safety in financial transactions, and has infinite expandability to various fields.

Next, the client terminal 10 transmits the generated transaction-signing OTP to the payment server 30 at step 450. As an embodiment, the payment server 30 may receive the transaction-signing OTP and autonomously verify it, and then transfer the results of verification to the client terminal 10. As another embodiment, a verification request and the results of verification may be transferred through the verification server 40.

After verification has been completed, the client terminal 10 receives a payment completion message (or transaction/verification completion message) as the results of verification at step 460. That is, after the results of verification have been received, another transaction may be performed or a current transaction may be completed on the trusted App 132. When a payment completion message is not received or when an authentication-denied message is received, the client terminal may again request the payment server 30 to process payment at step 410, and then a transaction-signing OTP may be regenerated.

In accordance with the method for generating a transaction-signing OTP according to the present invention, there is an advantage in that the user does not need to hold a hardware OTP token device, and a client terminal carried by the user is used, and thus the loss of the OTP device may be promptly perceived and reported. Further, when the battery of a hardware OTP token device is exhausted, the battery must be replaced by paying additional fees, whereas the transaction-signing OTP generation system according to the present invention has the effect of cost reduction in that regard.

Further, since OTP generation and financial transactions are performed using a separate trusted OS on the client terminal, safety and security are ensured. In addition, even if an OTP number is leaked in the OTP number input/output stage, verification using transaction information is possible in a verification stage, thus preventing the OTP number from being illegally used by a third party. Furthermore, a transaction-signing OTP according to the present invention is capable of replacing various types of security means such as a security card, a hardware OTP token device, a USB security key, a SMS OTP, CAPTCHA (virtual keyboard), SMS, and a certificate, and does not require additional authentication, thus improving the user's convenience. As a result, the present invention has expandability to various transaction fields including financial transactions.

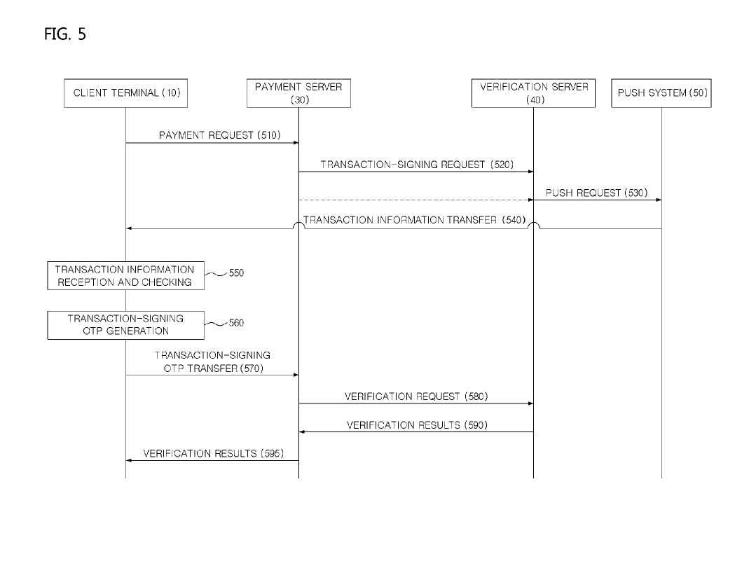

FIG. 5 is a swimlane diagram showing a transaction method using a transaction-signing OTP according to an embodiment of the present invention. As described above with reference to FIG. 4, the client terminal 10 may perform a financial transaction, e-commerce, and m-commerce process using the trusted App 132.

The client terminal 10 receives input information required for transaction, such as a payment amount (or a transfer amount) and a transfer account, depending on the user's input upon performing a financial transaction or e-commerce and m-commerce. For example, when a money transfer transaction is performed, the client terminal 10 receives transfer information from the user and transmits a transfer request to the payment server 30 at step 510. As another example, when payment is processed in an online website, the client terminal 10 transmits a payment request to the payment server 30 at step 510.

The payment server 30 receives the payment request from the client terminal 10 at step 510, and transfers a transaction-signing request to the verification server 40 at step 520. That is, the payment server 30 requests the verification server 40 to perform transaction signing so as to process a transaction using a transaction-signing OTP. The verification server 40 receives the transaction-signing request from the payment server 30, and then transmits a push request to the push system 50 at step 530. The push system 50 receives the push request from the verification server 40, and then transmits the transaction information in the form of a push message to the client terminal 10 at step 540. In the present embodiment, an example in which transaction information is transmitted through the push system 50 has been described, but the present invention may be implemented such that transaction information is transmitted from the payment server 30 or the verification server 40 to the client terminal 10 without passing through the push system.

The client terminal 10 may check the received transaction information via the trusted App 132 at step 550. For example, when the user checks the transaction information and approves the generation of an OTP, the trusted App may automatically generate a transaction-signing OTP at step 560. The client terminal 10 may generate a transaction-signing OTP using part or all of the transaction information received from the push system 50 upon generating the transaction-signing OTP. The transaction information may include a bank ID code, an account number, a transfer amount, etc. upon performing financial transactions, and include the name of a purchased product, a purchase amount, a purchasing place, etc. upon performing e-commerce and m-commerce. An OTP number may be generated using a hash algorithm upon generating the transaction-signing OTP.

When the transaction-signing OTP is generated, the client terminal 10 transfers the OTP to the payment server 30 at step 570. The payment server 30 requests the verification server 40 to verify the transaction-signing OTP at step 580. The verification server 40 transfers the results of verification of the received transaction-signing OTP to the payment server 30, and allows the verification results to be transferred to the client terminal 10 at steps 590 and 595.

The verification results may be transferred in the form of a payment completion message (or transaction/verification completion message) or, alternatively, the payment may be automatically completed when verification is completed. When the payment completion message is not received or when an authenticated-denied message is received, the client terminal may again request the payment server 30 to process payment, thus enabling a transaction-signing OTP to be regenerated.

In accordance with the transaction-signing OTP generation method, safety and security are ensured. In addition, even if an OTP number is leaked in an OTP input/output stage, verification using transaction information is possible in a verification stage, thus preventing the OTP number from being illegally used by a third party. Furthermore, there is an advantage in that the transaction-signing OTP according to the present invention may replace various types of security means such as a security card, a hardware OTP token device, a USB security key, a SMS OTP, CAPTCHA (virtual keyboard), SMS, and a certificate.

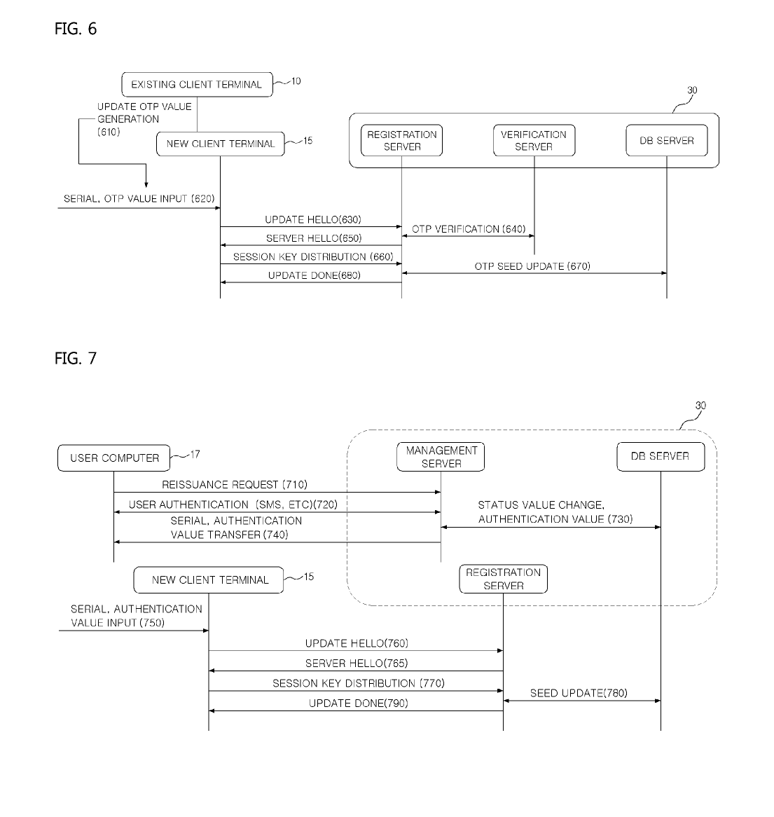

Hereinafter, additional functions in transactions using a transaction-signing OTP will be described in detail with reference to FIGS. 6 to 8.

FIG. 6 illustrates a key update protocol for a transaction-signing OTP. When a client terminal is replaced with a new one, an existing client terminal 10 generates an OTP value for update at step 610, and a new client terminal 15 may update an OTP seed in the database (DB) of the payment server 30 by inputting the OTP value for update and a serial value at step 620. The payment server 30 verifies the OTP value, and registers the same serial value as the input serial value and a new OTP value in the new client terminal at steps 630 to 670. By means of this function, even if the client terminal is replaced, the OTP generation function may be used in the same manner as that of the existing terminal, and registration and management on the payment server are facilitated.

FIG. 7 illustrates a reissuance protocol for a transaction-signing OTP. When an OTP cannot be updated by an existing client terminal, an OTP may be reissued by a new client terminal and may be used. For example, when a user requests a payment server 30 to reissue an OTP over the Internet using a user terminal 17, user authentication is performed, and the payment server 30 transfers a serial value and an authentication value to the user at steps 710 to 740. The user inputs the received serial value and authentication value to a new client terminal 15, and transmits them to the payment server 30, so that the payment server 30 updates the authentication value and an OTP seed, thus enabling the serial value and a new OTP key value to be registered at steps 760 to 790.

When an OTP key is updated or reissued by the new client terminal, a description has been made based on data communication between the payment server 30 and the client terminal 10 in the above example. The payment server 30 may individually include a registration server, a verification server, a DB server, and a management server to process registration or reissuance tasks in conjunction with the servers. Alternatively, the servers may also be integrated into a single server.

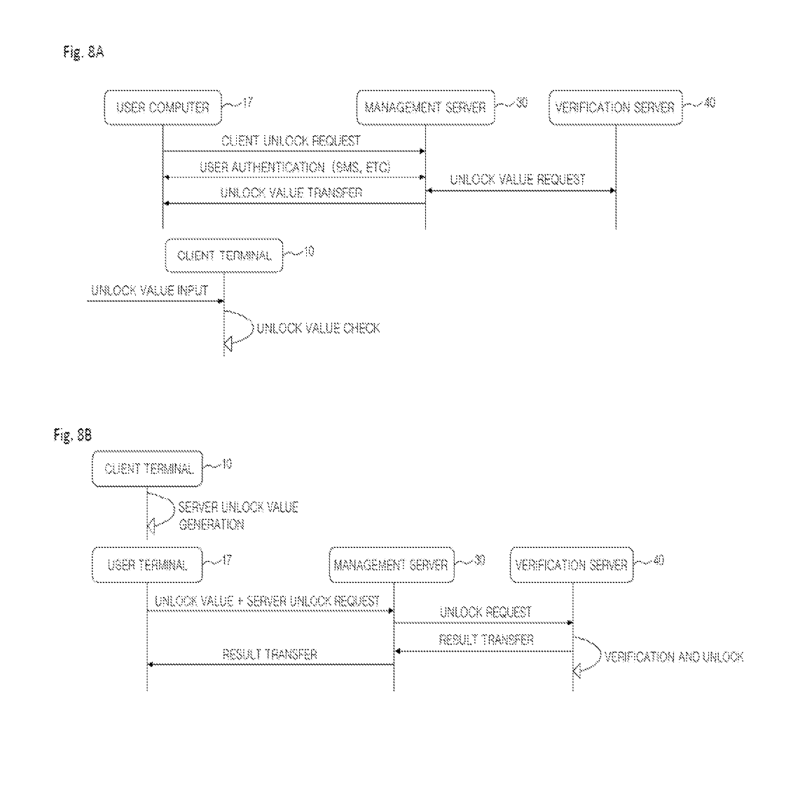

FIGS. 8A and 8Ba illustrate an unlock protocol for a transaction-signing OTP on a client terminal or a payment server. A transaction-signing OTP generation system according to the present invention has a function of switching a client terminal 10 to a lock mode when the verification of the user's Personal Identification Number (PIN) fails a preset number of times or more (FIG. 8A). Even in this case, the user may access a management server 30 using another terminal 17, request the management server 30 to unlock the client terminal, obtain authentication, receive an unlock value, and input the unlock value to the locked client terminal 10, thus enabling the lock mode of the client terminal 10 to be conveniently released. In conventional technology, when the entry of a password fails, a transaction itself is unavailable, and there are many cases where a locked state may be released only when the user personally visits a required institution such as a bank and resets a password through direct interaction with a clerk. However, the present invention may use an unlock function, thus improving the user's convenience.

As another example, when verification fails in a server stage, the OTP of the payment server 30 may be set to a lock mode (FIG. 8B). In this case, an unlock value may be generated by the client terminal 10. When the client terminal 10 generates an unlock value, accesses the payment server 30, and requests the payment server 30 to unlock the server (release from the locked state of the server), the server may verify the unlock value through the verification server 40, and release the lock mode of the server.

In this way, when the verification of the user's PIN or verification at the server fails, the mode is automatically set to a client lock mode or a server lock mode, so that the present invention may be flexibly used compared to uniform prohibition of transactions. In addition, the user may access the server using another terminal and easily release the lock mode via authentication, thus eliminating the inconvenience of having to personally visit the institution. Furthermore, even the corresponding institution can reduce tasks not directly related to financial transactions, thus simplifying tasks and improving task efficiency.

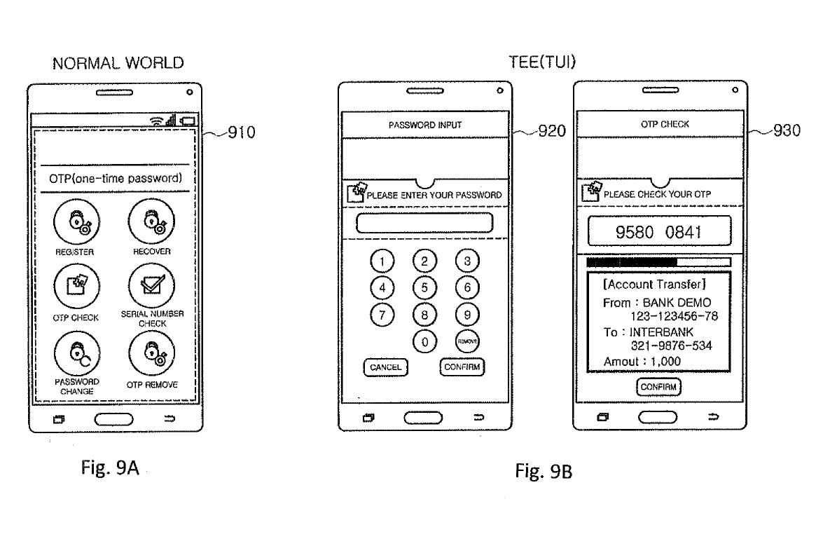

FIGS. 9A and 9B illustrate screen shots showing an execution screen of a trusted UI according to an embodiment of the present invention. FIGS. 9A and 9B are intended to describe examples of the trusted UI described in FIGS. 2 and 3, and show screen shots when the trusted UI is implemented in an actual client terminal 10.

A screen shown in FIG. 9A illustrates a normal application and a normal UI screen executed in the normal world, and FIG. 9B illustrates a trusted application and a trusted UI screen executed in a TEE (trust zone).

The user of the client terminal 10 runs the normal application installed in the normal world. Here, the normal application is an application working in conjunction with a trusted application according to the present invention. Since the user cannot immediately access and run the trusted application, a normal application capable of calling a trusted application is provided and runs upon generating an OTP.

FIG. 9A illustrates a normal UI screen 910 executed in the normal world when a user runs a normal application. On the normal UI screen 910, all normal terminal operations (e.g., capture) are possible. When a menu requiring security, such as OTP registration and OTP checking, is selected on the shown normal application, the normal application calls (links to) a trusted application, and then runs the trusted application.

The operation of the trusted application is supported by a trusted OS, and the trusted application displays a trusted UI (TUI) on a display unit. As described above, since the trusted UI is displayed with highest priority at a level higher than that of a normal UI, it is impossible to access the trusted UI in the normal world, and screen touch coordinates or the like are implemented not to be known in the normal world, thus guaranteeing the security of financial transactions, e-commerce or m-commerce, which are executed via the TEE (trust zone).

In the present embodiment, the trusted UI is used for an OTP Personal Identification Number (PIN) input screen 920 and an OTP generation result screen 930. After the PIN has been authenticated, even an OTP generation value may be securely protected from a risk of hacking via the trusted UI screen.

When a trusted UI 136 is executed and the trusted screen is executed, all operations in the normal world are temporarily stopped, and an application in the TEE based on a separate OS (that is, a trusted OS) runs, and thus an attacker's access itself is blocked. In this case, with the exception of a keypad for entry, even hardware control keys such as a home button or a back button are not operated, thereby preventing hardware-based data transmission caused by a capture or recording. The trusted UI may be implemented such that, in order to return to the normal world, only a SW back button provided by the trusted UI may be used.

When the trusted UI is executed, the TEE may acquire all authority for screen input/output to prevent the input/output of data, and may also prohibit the capture or recording of the output screen. For example, even if a trusted screen is implemented via an existing software security scheme, there is no method of blocking a screen capture performed based on the hardware capture scheme of a client device (e.g., a scheme for capturing a screen when the home key and the power key are simultaneously pressed). However, when the trusted UI 920 or 930 implemented in the present invention is executed, a screen capture or recording is prevented from occurring even by a screen capture operation. Further, all coordinates input to the screen cannot be externally extorted, thus preventing the forgery/falsification of data. When the trusted UI 920 or 930 according to the present invention is executed, an additional security device such as an existing virtual keyboard is not required, so that forgery/falsification of data is prevented without requiring a separate security solution, and the security of a keyboard and coordinates becomes possible, thus obtaining an advantage of economical efficiency.

FIG. 10 is a diagram showing an E2E protocol according to an embodiment of the present invention. A TZ OTP proposed in the present invention adopts an E2E encryption (end-to-end encryption) scheme. To use an OTP, a key (secret key) value required for the generation of an OTP must be shared. In the system of the present invention, a server generates an OTP key, transfers the OTP key to a TZ OTP (Trusted Application: TA), and uses the OTP key. In this case, to securely transfer the OTP key, the OTP key is encrypted using a specific key value and is then used. In a TSM, a function of distributing keys to a client and a server (TSM personalization) is provided.

A Trusted Service Manager (TSM) functioning as a server in a TEE, or as a separate server may also be referred to as another name such as a Trusted Application Manager (TAM), and shares a static key with a TZ OTP client 2100 and a TZ OTP server 2400 using a personalization data function at step 1010.

Here, a TSM 2200 according to the present invention has a key distribution scheme (key personalization), derives another key from the corresponding key using this function of the TSM (key personalization function) and uses the derived key to encrypt an OTP key value. When a TZ OTP is registered in the TSM, a manager generates a personalization master key, registers it in the TSM, installs a service provider via the TSM, and also installs the TZ OTP. Then, a personalization key derived from the registered personalization master key is generated. After the TZ OTP has been installed, a personalization object installation procedure occurs, during which the personalization key is installed.

After the TSM 2200 has distributed the static key, the TZ OTP client 2100 transmits a company code at an initialize stage, and the TZ OTP server 240 checks the company code, generates a server random value at steps 1020 and 1030, and transmits the server random value to the TZ OTP client 2100.

After the TZ OTP client 2100 has generated a client random value at step 1040, it generates a session key to be used for E2E encryption, and generates a client cryptogram to authenticate and verify the session key generated by the TZ OTP client 2100 at steps 1050 and 1060. In this regard, specific values of the session key and the client cryptogram are generated by the following equations in such a way that the session key is generated by encrypting the client random value, the server random value, and a hash value of the company code using the static key, and the cryptogram is generated by hashing the client random value, the server random value, the company code, and the session key.

Session key=Encrypt Static Key(Client Random+Server Random+HASH(Company Code))

Cryptogram=HASH(Client Random+Server Random+Company Code+Session Key)

For authentication and verification, the TZ OTP client 2100 transmits the generated client random value and client cryptogram to the TZ OTP server 240. The TZ OTP server 240 that receives them generates a session key to be used for E2E encryption at step 1070, verifies the client cryptogram at step 1080, and generates a server cryptogram to authenticate and verify the session key generated by the server at step 1090.

The TZ OTP server 240 transmits the generated server cryptogram to the TZ OTP client 2100, and the TZ OTP client 2100 that receives the server cryptogram verifies the server cryptogram at step 1110.

Next, the TZ OTP server 240 generates a symmetric key (secret key) required to generate an OTP, encrypts the symmetric key using a shared session key, and transmits the encrypted symmetric key at step 1120. The TZ OTP client decrypts the encrypted symmetric key using the shared session key, thus allowing the TZ OTP client and the TZ OTP server to share the symmetric key (secret key) with each other at step 1130.

In this way, the E2E encryption scheme proposed in the present invention is used, so that there is an advantage in that a chip value required to generate a TZ OTP may be encrypted using a shared key, and the key may be securely delivered from the server to the TEE. The E2E encryption scheme of the present invention is applied to the TEE (trust zone) technology of the present invention, thereby enabling encryption technology having maximized security and safety to be implemented.

Furthermore, OTP (TZ OTP) technology based on trust zone technology proposed in the present invention is an epoch-making technology for satisfying a regulation indicating “Medium that is an electronic financial transaction means is to be used separately from a medium that is a transaction authentication means such as a one-time password” defined in Article 34 of Electronic Financial Transaction Act (compliance details in electronic financial transactions), and then grafting OTP technology onto a mobile device. Since conventional technologies in which OTP is combined with a mobile terminal did not satisfy the medium separation regulation, there was a problem in actual practicability (e.g., a software OTP is implemented using an OTP App installed in the normal world), or there was the inconvenience of needing to possess a separate OTP generation medium (e.g., a normal OTP is generated using an exclusive hardware device, and a Near Field Communication (NFC) OTP has a form in which an OTP authentication module is contained in a separate IC card). However, since the present invention uses technology for a TEE separated in hardware, there is no need to add separate hardware to a mobile phone or replace corresponding hardware, thus resulting in advantages in that the propagation of technology and improvement of security are promoted while the user's convenience is improved.

In addition, the E2E encryption scheme of the present invention is advantageous in that a key required to generate an OTP is stored in an unhackable TEE (trust zone), with the result that data forgery/falsification may be prevented. A conventional software OTP has difficulty in coping with threats of the duplication of malicious code or the like and of data forgery, whereas the present invention may sufficiently compensate for vulnerabilities in the conventional technology.

In accordance with the transaction-signing OTP generation method and apparatus according to the present invention, there is no need to hold a hardware OTP token device, and a user's mobile terminal is used, so that prompt recognition and report are possible even if the mobile terminal is lost. Further, the battery of the hardware OTP token device must be replaced when it is exhausted by paying additional fees, whereas the present invention may reduce costs required to replace the battery thereby improving economical efficiency. When a conventional dongle OTP device is replaced with the present invention, an advantage of very high practicability and scalability may be obtained in that there is no need to physically construct an integrated authentication center, and in that the present invention is usable in various fields without causing additional costs.

In accordance with the transaction-signing OTP generation method and apparatus according to the present invention, since OTP generation and financial transactions are performed using a separate trusted OS on a client terminal, safety and security are ensured. In addition, even if an OTP number is leaked in an OTP number input/output stage, verification using transaction information is possible in a verification stage, thus preventing the OTP number from being used for other transactions or being illegally used by a third party. That is, a conventional scheme enables a user to check transfer details or purchase/payment details upon performing a financial transaction or e-commerce and m-commerce, but is problematic in that in actual transactions, an account number or the like is changed due to hacking. In contrast, in the case of a transaction-signing OTP proposed in the present invention, a transaction-signing OTP is generated from the transaction information itself checked on a smart phone without change, thus preventing damage caused by a change in data values during transactions. In spite of an advantage in which a transaction-signing OTP is more secure than a current scheme, the transaction-signing OTP has not yet been commercialized to date due to an inconvenience causing a customer to re-input the same transaction details. However, when an OTP is implemented according to the TZ OTP scheme proposed in the present invention, a customer may check his or her transaction details, and the transaction details may be automatically input in a secure manner even if the customer does not re-input the transaction details, thus improving convenience and enabling a transaction-signing OTP to be commercialized. Further, memory hacking or the like may be prevented using a scheme similar to that of a current scheme, thus satisfying security and practicability.

Furthermore, a transaction-signing OTP according to the present invention is capable of replacing various methods such as a security card, a USB security key, a SMS OTP, CAPTCHA (virtual keyboard), SMS and a certificate and does not require additional authentication, thus contributing to the improvement the user's convenience.

The present invention is advantageous in that it may provide a hardware-based separated TEE, and, in particular, completely prevent the forgery/falsification of data at an input/output stage via the implementation of trusted UI technology, and also prevent data transmission and screen capture operation, thus compensating for vulnerabilities in software-based security technology, and guaranteeing integrity at the input/output stage.

In addition, the E2E encryption scheme proposed in the present invention is used, so that there is an advantage in that a chip value required to generate a TZ OTP may be encrypted using a shared key, and the key may be securely delivered from the server to the TEE. The E2E encryption scheme of the present invention is applied to the TEE (trust zone) technology of the present invention, thereby enabling encryption technology having maximized security and safety to be implemented.

In the above description, the present invention has been described in detail only based on the specific examples for easy understanding of the present invention, and thus components described in the present specification, connections and relationships thereof, and the functions thereof are merely exemplary. In the present invention, individual components may be implemented in physically separate forms or an integrated form into which one or more components are integrated according to the circumstances.

Even if all components constituting the embodiment of the present invention are described as being combined into a single component or being combined and operated, the present invention is not necessarily limited to such an embodiment. That is, within the range of the object of the present invention, one or more of all components may be selectively combined and operated.

In the present specification, it should be understood that the terms such as “include”, “consist of” or “have” are merely intended to indicate that a given component may be present, and are not intended to exclude a possibility that one or more other components will be present or added. Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

The above description is merely intended to illustratively describe the technical spirit of the present invention, and those skilled in the art to which the present invention pertains, various changes and modifications may be possible without departing from the essential features of the present invention. Therefore, the embodiments disclosed in the present invention are not intended to limit the technical spirit of the present invention and are merely intended to describe the present invention, and the technical spirit of the present invention is not limited by those embodiments of the present invention. The scope of protection of the present invention should be interpreted by the accompanying claims, and all technical spirits in equivalents thereof should be interpreted as being included in the scope of the present invention.

What is claimed is:

1. A method for generating a transaction-signing One-Time Password (OTP), comprising:
transmitting a payment request to a payment server using a trusted application running on a client terminal;
receiving transaction information in response to the transaction request; and
generating a transaction-signing OTP including the transaction information as an input value by using the trusted application,
wherein an application processor of the client terminal is logically separated into a normal world and a Trusted Execution Environment (TEE), and
wherein when the trusted application runs, the TEE has authority for all hardware and software operations of the client terminal, and a Trusted User Interface (TUI) displayed at a level higher than that of a normal UI is executed.

2. The method of claim 1, wherein the trusted application is executed by a trusted Operating System (OS) running independent of a normal OS running on the client terminal.

3. The method of claim 1, wherein the transaction information includes a bank ID code, an account number, and a transfer amount.

4. The method of claim 1, wherein the transaction information includes a name of a purchased product, a purchase amount, and a purchasing place.

5. The method of claim 1, wherein receiving the transaction information in response to the transaction request is configured to receive the transaction information in a form of a push message through a push system operating in conjunction with the payment server.

6. The method of claim 1, further comprising:
transmitting the generated transaction-signing OTP to the payment server; and
receiving results of verification of the transaction-signing OTP.

7. The method of claim 1, wherein the transaction-signing OTP is generated by a second client terminal using a key update protocol or a reissuance protocol.

8. The method of claim 1, wherein the trusted application runs in such a way as to be called or linked using a predefined function of a normal application running in the normal world.

9. The method of claim 1, wherein the trusted UI is configured such that, when the trusted UI is executed, the TEE acquires all authority for input/output of a screen, thus preventing data transmission to outside, a screen capture, and a recording from being manipulated.

10. The method of claim 1, wherein:
the TEE previously holds a static key distributed by a Trusted Server Manager (TSM) both to the client terminal and to the payment server,
the client terminal and the payment server respectively generate session keys encrypted using the static key, and
when the payment server generates a symmetric (secret) key required for generation of the transaction-signing OTP by encrypting the symmetric key using the corresponding session key and transmits the symmetric key to the client terminal, the client terminal that receives the symmetric key decrypts the encrypted symmetric key using the corresponding session key.

11. An apparatus for generating a transaction-signing OTP using a trusted application, comprising:
an interface for transmitting a transaction request to a payment server through the trusted application and receiving transaction information in response to the transaction request;
an OTP generation processor for generating a transaction-signing OTP using the received transaction information as an input value; and
a display unit for displaying processing status of a transaction depending on a user's input using the interface, and displaying the received transaction information,
wherein the interface transmits the transaction-signing OTP generated by the OTP generation processor to the payment server, receives results of verification, and displays the results of verification on the display unit.
wherein an application processor of the client terminal is logically separated into a normal world and a Trusted Execution Environment (TEE), and
wherein when the trusted application runs, the TEE has authority for all hardware and software operations of the client terminal, and a Trusted User Interface (TUI) displayed at a level higher than that of a normal UI is executed.

12. The apparatus of claim 11, wherein the trusted application is executed by a trusted Operating System (OS) running independent of a normal OS running on a client terminal.

13. The apparatus of claim 11, wherein the transaction information includes a bank ID code, an account number, and a transfer amount.

14. The apparatus of claim 11, wherein the transaction information includes a name of a purchased product, a purchase amount, and a purchasing place.

15. The apparatus of claim 11 wherein the transaction information is received in a form of a push message through a push system operating in conjunction with the payment server.

16. The apparatus of claim 11, wherein the trusted application runs in such a way as to be called or linked using a predefined function of a normal application running in the normal world.

17. The apparatus of claim 11, wherein the trusted UI is configured such that, when the trusted UI is executed, the TEE acquires all authority for input/output of a screen, thus preventing data transmission to outside, a screen capture, and a recording from being manipulated.

18. The apparatus of claim 11, wherein:
the TEE previously holds a static key distributed by a Trusted Server Manager (TSM) both to the client terminal and to the payment server,
the client terminal and the payment server respectively generate session keys encrypted using the static key, and
when the payment server generates a symmetric (secret) key required for generation of the transaction-signing OTP by encrypting the symmetric key using the corresponding session key and transmits the symmetric key to the client terminal, the client terminal that receives the symmetric key decrypts the encrypted symmetric key using the corresponding session key.

19. A system using a transaction-signing OTP, comprising:
a client terminal for transmitting a transaction request using a trusted application, receiving transaction information in response to the transaction request, and generating a transaction-signing OTP including the transaction information as an input value;
a payment server for receiving the transaction request and transmitting a transaction-signing request;
a verification server for receiving the transaction-signing request and transferring the transaction-signing request to a push server; and
the push server for receiving the transaction-signing request from the verification server, and transmitting the transaction information corresponding to the transaction-signing request to the client terminal,
wherein an application processor of the client terminal is logically separated into a normal world and a Trusted Execution Environment (TEE), and
wherein when the trusted application runs, the TEE has authority for all hardware and software operations of the client terminal, and a Trusted User Interface (TUI) displayed at a level higher than that of a normal UI is executed.

20. The system of claim 19, wherein:
the client terminal transmits the generated transaction-signing OTP to the payment server, and
the payment server verifies the transaction-signing OTP via the verification server, and transfers results of verification to the client terminal.

21. The system of claim 19, wherein the trusted application is executed by a trusted Operating System (OS) running independent of a normal OS running on the client terminal.

22. The system of claim 19, wherein the transaction information includes a bank ID code, an account number, and a transfer amount.

23. The system of claim 19, wherein the transaction information includes a name of a purchased product, a purchase amount, and a purchasing place.

24. The system of claim 19, wherein the trusted application runs in such a way as to be called or linked using a predefined function of a normal application running in the normal world.

25. The system of claim 19, wherein the trusted UI is configured such that, when the trusted UI is executed, the TEE acquires all authority for input/output of a screen, thus preventing data transmission to outside, a screen capture, and a recording from being manipulated.

26. The system of claim 19, wherein:
the TEE previously holds a static key distributed by a Trusted Server Manager (TSM) both to the client terminal and to the payment server,
the client terminal and the payment server respectively generate session keys encrypted using the static key, and
when the payment server generates a symmetric (secret) key required for generation of the transaction-signing OTP by encrypting the symmetric key using the corresponding session key and transmits the symmetric key to the client terminal, the client terminal that receives the symmetric key decrypts the encrypted symmetric key using the corresponding session key.
